(19) United States
(12) Patent Application Publication
(10) Pub. No.: US 2021/0094560 A1
(43) Pub. Date: Apr. 1, 2021

(54) VEHICLE STEERING BACKUP

(71) Applicant: Robert Bosch GmbH, Stuttgart (DE)

(72) Inventors: Jin-Gen Wu, Ann Arbor, MI (US); Fu-Long Chang, Ann Arbor, MI (US); Frank Juergen Stuetzler, South Lyon, MI (US); Thierry Kegne Fongue, Plymouth, MI (US); Wenguang Zhou, Novi, MI (US); Tong Mu, Plymouth, MI (US); Chi Chuang, Ann Arbor, MI (US)

(21) Appl. No.: 16/586,172

(22) Filed: Sep. 27, 2019

(51) Int. Cl. B60W 50/029; B60W 10/18; B60W 10/20; B60W 30/045; B60W 10/12

(52) U.S. Cl. CPC B60W 50/029; B60W 10/18; B60W 10/20; B60W 30/045; B60W 10/12; B60W 2710/12; B60W 2520/14; B60W 2510/20; B60W 2710/18; B60W 2710/20; B60W 2540/18

(57) ABSTRACT

Systems and methods for a steering a vehicle. In one example, a system includes a first wheel, a second wheel, and a skid/differential steering system including an electronic processor. The electronic processor is configured to receive, from an electronic power steering system, a steering failure signal and a target steering angle, determine, based on the target steering angle, a target yaw rate, and drive the first wheel of the vehicle forward and decelerate the second wheel of the vehicle based on the target yaw rate, turning the vehicle.

### FIELD

Vehicles include braking systems in order to slow and stop the vehicle. Many vehicles utilize a frictional braking system, for example, a hydraulic system that forces brake pads against rotors, to provide a mechanical or frictional braking force to reduce the vehicle's speed. The braking force may also be utilized in the case of a steering system failure.

### SUMMARY

During a steering component or steering system failure, the vehicle may apply hydraulic braking on one side of the vehicle to create a target yaw rate to steer the vehicle (a function referred to as skid/differential steering). However, the application of the hydraulic braking alone has several restrictions. The response time of the hydraulic braking may be limited as the system needs time to build pressure for the braking (for example, approximately 700 ms-300 ms to build pressure from 0 to 180 bar). The resulting turning radius of the vehicle may also be limited (for example, approximately 102 meters, whereas most highway ramps have approximately 60 meter radiuses). Additionally, the vehicle slows down during skid/differential steering application, which may risk collision when another vehicle is driving behind the vehicle. skid/differential steering is further restricted by vehicle suspension configuration in that the kingpin offset should be positive (the top of the steering axis being closer to the vehicle centerline). By utilizing propulsion in addition to braking, the steering radius and timing thereof may be increased.

One embodiment presented herein includes a system for steering a vehicle. The system includes a first wheel, a second wheel, and a skid/differential steering system including an electronic processor. The electronic processor is configured to receive, from an electronic power steering system, a steering failure signal and a target steering angle, determine, based on the target steering angle, a target yaw rate, and drive a first wheel of the vehicle forward and decelerate a second wheel of the vehicle based on the target yaw rate, turning the vehicle.

Another embodiment provides a method for steering a vehicle. The method includes receiving, from the electronic power steering system, a steering failure signal and a target steering angle, determining, based on the target steering angle, a target yaw rate, and driving a first wheel of the vehicle forward and decelerate a second wheel of the vehicle based on the target yaw rate, turning the vehicle.

Another embodiment provides a vehicle including a first wheel, a second wheel, and a skid/differential steering system including an electronic processor. The electronic processor is configured to receive, from an electronic power steering system, a steering failure signal and a target steering angle, determine, based on the target steering angle, a target yaw rate, and drive a first wheel of the vehicle forward and decelerate a second wheel of the vehicle based on the target yaw rate, turning the vehicle.

Other aspects will become apparent by consideration of the detailed description and accompanying drawings.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed subject matter, and explain various principles and advantages of those embodiments.

FIG. 1 is a block diagram of a vehicle system, according to some embodiments.

FIG. 2 is a flow chart of method of operating the braking system of FIG. 1, according to some embodiments.

FIG. 3 is a block diagram illustrating the steering backup applied in the vehicle system of FIG. 1 according to the method of FIG. 2, according to some embodiments.

FIG. 4 is a diagram illustrating the calculation of the target yaw rate according to some embodiments.

The apparatus and method components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

### DETAILED DESCRIPTION

Before any embodiments are explained in detail, it is to be understood that the examples presented herein are not limited in their application to the details of construction and the arrangement of components set forth in the following description or illustrated in the following drawings. Embodiments may be practiced or carried out in various ways.

It should also be noted that a plurality of hardware and software based devices, as well as a plurality of different structural components may be used to implement the embodiments presented herein. In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects may be implemented in software (for example, stored on non-transitory computer-readable medium) executable by one or more processors. As such, it should be noted that a plurality of hardware and software based devices, as well as a plurality of different structural components may be utilized to implement the embodiments presented. For example, “control units” and “controllers” described in the specification can include one or more processors, one or more memory modules including non-transitory computer-readable medium, one or more input/output interfaces, and various connections (for example, a system bus) connecting the components.

For ease of description, each of the example systems presented herein is illustrated with a single exemplar of each of its component parts. Some examples may not describe or illustrate all components of the systems. Other embodiments may include more or fewer of each of the illustrated components, may combine some components, or may include additional or alternative components.

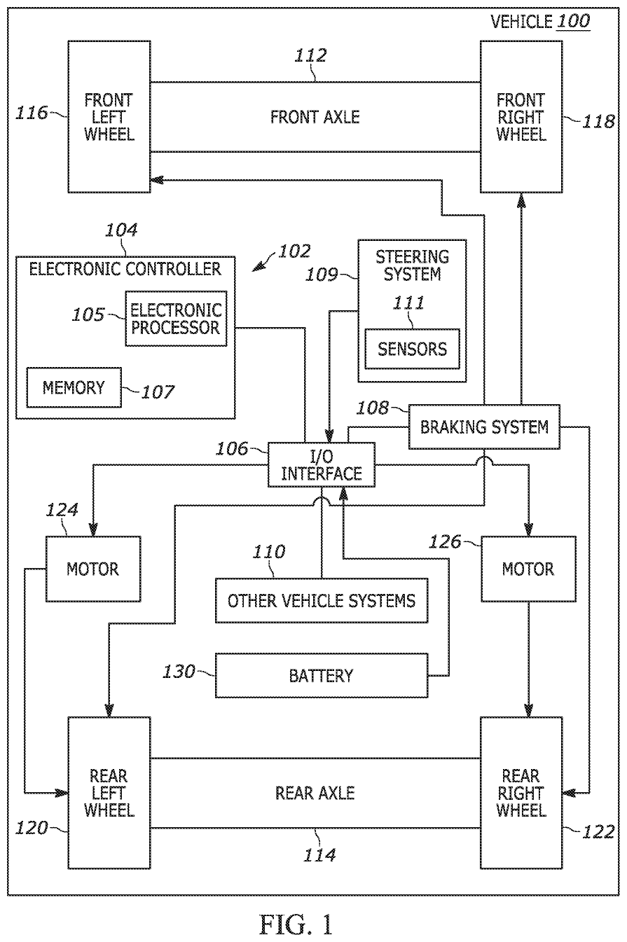

FIG. 1 is a block diagram of an example vehicle 100 that includes an skid/differential steering system 102. In the example illustrated, the system 102 includes an electronic controller 104, an input/output (I/O) interface 106, a braking system 108, an electronic power steering system 109, and other vehicle systems 110. The vehicle 100 also includes a front axle 112, a rear axle 114, a front left wheel 116, a front right wheel 118, a rear left wheel 120, a rear right wheel 122. The front left and right wheels 116 and 118 are coupled to the front axle 112. Likewise, the rear left and right wheels 120 and 122 are coupled to the rear axle 114. The rear left wheel 120 and the rear right wheel 122 are each driven by rear left motor 124 and rear right motor 126 respectively. The motors 124 and 126 may be electric motors. In some embodiments, the front left wheel 116 and the front right wheel 118 are similarly driven by respective motors (not shown).

The electronic controller 104, the braking system 108, the steering system 109, and the other vehicle systems 110, as well as other various modules and components of the vehicle 100 are coupled to each other by or through one or more control or data buses (for example, a CAN bus), which enable communication therebetween. The use of control and data buses for the interconnection between and exchange of information among the various modules and components would be apparent to a person skilled in the art in view of the description provided herein.

In some embodiments, the electronic controller 104 includes a plurality of electrical and electronic components that provide power, operational control, and protection to the components and modules within the electronic controller 104. The electronic controller 104 may be or may include one or more electronic control units including, for example, an engine control module, a powertrain control module, a transmission control module, a general electronic module, and the like. The electronic controller 104 includes, among other things, an electronic processor 105 (for example, an electronic microprocessor, microcontroller, or other suitable programmable device), and a memory 107. The electronic controller 104 is also connected to the input/output interface 106. The electronic processor 105, the memory 107, and the input/output interface 106, as well as the other various modules are connected by one or more control or data buses. In some embodiments, the electronic controller 104 is implemented partially or entirely in hardware (for example, using a field-programmable gate array (“FPGA”), an application specific integrated circuit (“ASIC”), or other devices.

The memory 107 can include one or more non-transitory computer-readable media, and includes a program storage area and a data storage area. As used in the present application, “non-transitory computer-readable media” comprises all computer-readable media but does not consist of a transitory, propagating signal. The program storage area and the data storage area can include combinations of different types of memory, for example, read-only memory (“ROM”), random access memory (“RAM”), electrically erasable programmable read-only memory (“EEPROM”), flash memory, or other suitable digital memory devices. The electronic processor 105 is connected to the memory 107 and executes software, including firmware, one or more applications, program data, filters, rules, one or more program modules, and other executable instructions. The electronic processor 105 retrieves from the memory 107 and executes, among other things, instructions related to the control processes and methods described herein. In other embodiments, the electronic controller 104 may include additional, fewer, or different components.

The braking system 108 is a braking system that utilizes a frictional braking force to inhibit the motion of one or more of the wheels 116, 118, 120, and 122 in order to slow and/or stop the vehicle 100. For example, some or all of the wheels 116, 118, 120, and 122 are fitted with brake pads which apply a frictional braking force that inhibits the motion of rotors (not shown) connected to the wheels 116, 118, 120, and 122. In some embodiments, the braking system 108 is a conventional :hydraulic braking system. The braking system 108 may include a brake booster configured to increase the force a brake pad exerts on the wheel 116, 118, 120, and 122 of the vehicle 100.

In some embodiments, the braking system 108 includes a regenerative braking system. The regenerative braking system, during a braking maneuver, causes an electric motor (for example, motors 124 and 126) to act as a generator and stores or redistributes the power generated by the motor. The act of generating power creates a braking torque on the motor that is transmitted to one or more of the wheels 116, 118, 120, and 122 that the motor is coupled to. to slow and/or stabilize the vehicle 100. In some embodiments, the braking system 108 may include more than one motor each coupled or connected to at least one of the wheels 116, 118, 120, and 122. it should be understood any number of connections with any number of motors connected to any number of wheels is possible in further embodiments.

The vehicle 100 may further include a battery 130. The battery 130 provides power to the motors 124, 126 of the system 102 as well as other components of the vehicle 100. In some embodiments, the vehicle 100 is an autonomous or self-driving car. In other embodiments, the vehicle 100 requires human input to drive. In such embodiments, the system 102 includes a brake pedal. The brake pedal may be connected to the braking system 108. The vehicle 100 may be a two wheel or four wheel drive system.

The electronic power steering system 109 is configured to direct the vehicle by moving steering components connected to the front axle 112 based on a steering command (for example, a movement of a steering wheel). The steering system 109 includes one or more sensors 111. The steering system 109 may also include a steering wheel, servo motors, and the like (not shown). The sensors 111 may be configured to measure yaw dynamics of the vehicle 100 (for example, yaw rate, sideslip angle, steering wheel angle, superposition angle, vehicle speed, longitudinal acceleration, and lateral acceleration). This sensor information may be transmitted to the electronic controller 104.

The other vehicle systems 110 include controllers, sensors, actuators, and the like for controlling aspects of the operation of the vehicle 100 (for example, acceleration, braking, shifting gears, and the like). The other vehicle systems 110 are configured to send and receive data relating to the operation of the vehicle 100 to and from the electronic controller 104.

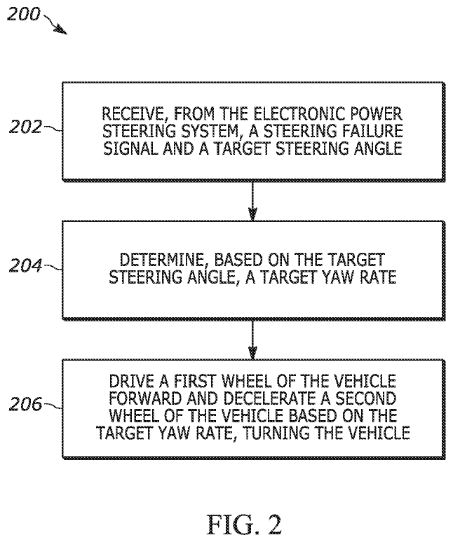

FIG. 2 is a flowchart of a method 200 for steering a vehicle (for example, vehicle 100). As an example, the method 200 is explained in terms of the electronic controller 104, in particular the electronic processor 105. However, it should be understood that portions of the method 200 may be distributed among multiple components of the vehicle 100.

At block 202, the electronic processor 105 receives, from the electronic power steering system 109, a steering failure signal and a target steering angle. The steering failure signal is indicative of a detected failure in the electronic power steering system 109, such that the steering functionality is compromised. The target steering angle is the desired angle in which the front axle 112 is to be positioned at (for example, based on the steering wheel position).

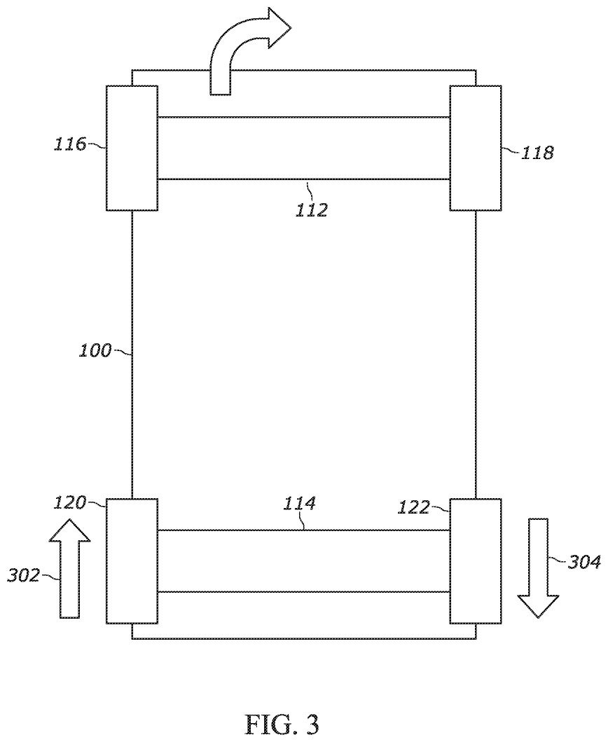

At block 204, the electronic processor 105 determines, based on the target steering angle, a target yaw rate and, at block 206, the electronic processor 105 drives (via motor 124 or 126) a first wheel of the vehicle forward and decelerates a second wheel (on the opposite side of the vehicle) of the vehicle based on the target yaw rate, turning the vehicle 100. For example, as illustrated in FIG. 3, when the target steering angle indicates that the vehicle 100 is to turn right, the rear left wheel 120 is driven forward, providing a propulsion force 302 while the rear right wheel 122 is decelerated. The deceleration may be achieved by controlling an application of a braking force to the second wheel or driving the second wheel backward. In the example illustrated, a brake is applied (via braking system 108) to the rear right wheel 122, producing braking force 304. In some embodiments, where the vehicle 100 is configured to perform regenerative braking, the electronic processor 105 decelerates the second by applying a reverse voltage to decelerate the second wheel. By driving the first wheel and reducing the speed of the second wheel on the opposite side, the vehicle 100 is able to turn accordingly.

In some embodiments, the vehicle 100 includes an electrically-controlled differential. In further embodiments, the first wheel and the second wheel are rotated via the electrically-controlled differential. In some embodiments, the driving of the first wheel and the deceleration of the second wheel may be done sequentially (at different times) or at the same time. In some embodiments, the processor 105 may drive or decelerate one or more additional wheels (for example, the front left wheel 116 and/or the front right wheel 118) of the vehicle 100 based on the target yaw rate. In some embodiments, the second wheel is the wheel diagonal from the first wheel.

The electronic processor 105 may determine the speed at which to drive the first wheel and/or the degree of deceleration to apply to the second wheel based on the target steering rate and the vehicle dynamic sensor information from the sensors 111 of the steering system 109 (for example, the speed of the vehicle). The electronic processor 105 may also utilize information from additional sensors of the vehicle 100 (for example, rearview image sensors, sideview image sensors, lane marking detection sensors, and the like). The electronic processor 105 may adjust the target yaw rate based on the additional information. For example, while performing block 206 of FIG. 2, the electronic processor 105 may determine, based on the sensor information, that the vehicle will cross a solid yellow lane marking. The electronic processor 105 may, in response, determine a new target yaw rate and adjust the control of the first and second wheels accordingly.

By using two wheels to steer the vehicle 100 when the steering system 109 has failed or is unavailable, the yaw rate in which the vehicle 100 is able to be moved is improved (approximately 50 meters). The speed of the vehicle 100 also does not reduce as significantly as compared to the single wheel method and the kingpin effect is reduced.

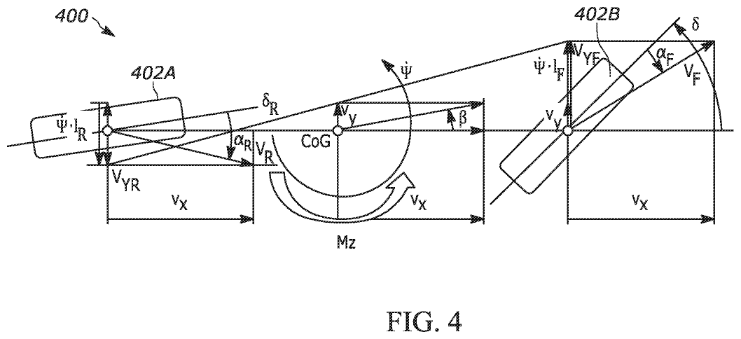

The target yaw rate may determined in several ways. For example, the following formula may be used.

$$\dot{ψ} = \frac{( {C}_{F} + {C}_{R} ) \cdot {V}_{x}}{{C}_{F} {C}_{R} \cdot {( {l}_{F} + {l}_{R} )}^{2} + m \cdot ( {C}_{R} {l}_{R} - {C}_{F} {l}_{F} ) \cdot {V}_{x}^{2}} \cdot {M}_{z} + \frac{( {C}_{F} {C}_{R} ) \cdot ( {l}_{F} + {l}_{R} ) \cdot {V}_{x}}{{C}_{F} {C}_{R} \cdot {( {l}_{F} + {l}_{R} )}^{2} + m \cdot ( {C}_{R} {l}_{R} - {C}_{F} {l}_{F} ) \cdot {V}_{x}^{2}} \cdot ( {δ}_{F} - {δ}_{R} ) \qquad [ 1 ]$$

where, M_{z} is the external yaw torque that is to be generated by accelerating and decelerating two or more wheels of the vehicle 100. Vₓ is the current speed of the vehicle 100, \dot{ψ} is the desired yaw rate, δ_{F} corresponds to the front axis steering angle, δ_{R} corresponds to the rear axis steering angle, C_{F} and C_{R} are the front and rear cornering stiffness, l_{F} is the length between the center of gravity (CoG) location of the vehicle 100 and the front axle 112, l_{R} is the length between the CoG and the rear axle 114, and m is the vehicle mass. FIG. 4 is a diagram 400 illustrating the variables of Equation 1 above according to an initial position 400A of the vehicle 100 and a target position 400B of the vehicle 100.

The external yaw torque M_{z} is the sum of the propulsion force and the braking force multiplied by half of the width W of the vehicle 100. Accordingly, the yaw rate contribution from the external yaw torque M_{z} may be determined based on the relationship between the external yaw torque M_{z} and the yaw rate of Equation 1, resulting in the following equation.

$$\dot{ψ} ( Mz ) = \frac{( {C}_{F} + {C}_{R} ) \cdot {V}_{x}}{{C}_{F} {C}_{R} \cdot {( {l}_{F} + {l}_{R} )}^{2} + m \cdot ( {C}_{R} {l}_{R} - {C}_{F} {l}_{F} ) \cdot {V}_{x}^{2}} \cdot ( propulsion force + braking force ) \cdot \frac{W}{2} \qquad [ 2 ]$$

Accordingly, a target yaw rate to be generated from an external yaw torque generated according to the propulsion and/or braking force exerted by the at least two wheels of the vehicle 100 in the method 300 above, may be determined.

Thus, embodiments provide, among other things, a braking system and method for a vehicle in case of a braking failure. Various features and advantages of the invention are set forth in the following claims.

In the foregoing specification, specific embodiments have been described. However, one of ordinary skill in the art appreciates that various modifications and changes may be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . ” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized electronic processors (or “processing devices”) such as microprocessors, digital signal processors, customized processors and field programmable gate arrays (FPGAs) and unique stored program instructions (including both software and firmware) that control the one or more electronic processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment may be implemented as a computer-readable storage medium having computer readable code stored thereon for programming a computer (for example, comprising an electronic processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A system for steering a vehicle, the system comprising
a first wheel;
a second wheel; and
a skid/differential steering system including an electronic processor configured to:
receive, from an electronic power steering system, a steering failure signal and a target steering angle;
determine, based on the target steering angle, a target yaw rate; and
drive the first wheel of the vehicle forward and decelerate the second wheel of the vehicle based on the target yaw rate, turning the vehicle.

2. The system of claim 1, wherein the electronic processor is configured to decelerate the second wheel by controlling an application of a braking force to the second wheel or driving the second wheel backward.

3. The system of claim 1, wherein the vehicle includes an electrically-controlled differential, and wherein the first wheel and the second wheel are rotated via the electrically-controlled differential.

4. The system of claim 1, wherein the first wheel is driven by a first motor and the second wheel is driven by a second motor.

5. The system of claim 1, wherein the first wheel and the second wheel are located at the rear of the vehicle.

6. The system of claim 1, wherein the vehicle is configured to perform regenerative braking and wherein decelerating the second wheel includes applying a reverse voltage to decelerate the second wheel.

7. A method of steering a vehicle, the method comprising receiving, from an electronic power steering system, a steering failure signal and a target steering angle;
determining, based on the target steering angle, a target yaw rate; and
driving a first wheel of the vehicle forward and decelerate a second wheel of the vehicle based on the target yaw rate, turning the vehicle.

8. The method of claim 7, wherein decelerating the second wheel includes controlling an application of a braking force to the second wheel or driving the second wheel backward.

9. The method of claim 7, wherein the vehicle includes an electrically-controlled differential, and wherein the first wheel and the second wheel are rotated via the electrically-controlled differential.

10. The method of claim 7, wherein the first wheel is driven by a first motor and the second wheel is driven by a second motor.

11. The method of claim 7, wherein the first wheel and the second wheel are located at the rear of the vehicle.

12. The method of claim 7, wherein the vehicle is configured to perform regenerative braking and wherein decelerating the second wheel includes applying a reverse voltage to decelerate the second wheel.

13. A vehicle comprising:
a first wheel;
a second wheel; and
a skid/differential steering system including an electronic processor configured to:
receive, from an electronic power steering system, a steering failure signal and a target steering angle;
determine, based on the target steering angle, a target yaw rate; and
drive the first wheel of the vehicle forward and decelerate the second wheel of the vehicle based on the target yaw rate, turning the vehicle.

14. The vehicle of claim 13, wherein the electronic processor is configured to decelerate the second wheel by controlling an application of a braking force to the second wheel or driving the second wheel backward.

15. The vehicle of claim 13, wherein the vehicle includes an electrically-controlled differential, and wherein the first wheel and the second wheel are rotated via the electrically-controlled differential.

16. The vehicle of claim 13, wherein the first wheel is driven by a first motor and the second wheel is driven by a second motor.

17. The vehicle of claim 13, wherein the first wheel and the second wheel are located at the rear of the vehicle.

18. The vehicle of claim 13, wherein the vehicle is configured to perform regenerative braking and wherein decelerating the second wheel includes applying a reverse voltage to decelerate the second wheel.
